(19) United States
(12) Patent Application Publication
(10) Pub. No.: US 2009/0262066 A1
(43) Pub. Date: Oct. 22, 2009

(54) DISPLAY DEVICE

(75) Inventors: Ryutaro Oke, Chiba (JP); Sachiko Yamazaki, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/388,565

(22) Filed: Feb. 19, 2009

(30) Foreign Application Priority Data
Feb. 27, 2008 (JP) 2008-046233

(51) Int. Cl. G09G 3/36

(52) U.S. Cl. 345/102

(57) ABSTRACT

An object of the present invention is to slow the deterioration in the uniformity of the surface brightness when all of the lights emit light under the same conditions in a display device having a backlight where local dimming control is possible. The present invention provides a display device having a display panel with a display region which is a set of a number of pixels, a direct backlight with a number of LED lights, a first control means for controlling the tone of each pixel, and a second control means for controlling the brightness of each LED light, and the display device has an illuminance measuring means for measuring the illuminance in the periphery of said display device, and the above described second control means makes the brightness of all of the LED lights the same in the case where the illuminance as measured by the above described illuminance measuring means is higher than a preset value and determines the brightness of each LED light on the basis of the tone of each pixel in the case where the illuminance is lower than the preset value.

The present application claims priority over Japanese Application JP 2008-046233 filed on Feb. 27, 2008, the contents of which are hereby incorporated into this application by reference.

### BACKGROUND OF THE INVENTION

(1) Field of the Invention

The present invention relates to a display device, and in particular, to a technology which is effective when applied to a liquid crystal display device having a direct backlight where LED lights are arranged in a matrix.

(2) Related Art Statement

Some conventional liquid crystal display devices have a direct backlight provided behind the liquid crystal display panel. The above described direct backlight is a backlight where a number of lights are arranged in a region which overlaps with the display region of the above described liquid crystal display panel, and fluorescent lamps or LED lights are used for the above described lights, for example.

Direct backlights using LED lights, as described above, (hereinafter referred to as LED backlights) have low power consumption and can easily be made thin in comparison with direct backlights using fluorescent lamps, as described above. Therefore, more and more liquid crystal display devices have been adopting LED backlights as described above in recent years.

In addition, the above described LED backlights have a number of LED lights arranged in a matrix, as described above, in a region which overlaps with the display region of the liquid crystal display panel, as described above, and thus, the brightness of the above described LED lights is controlled by the applied current. Therefore, the above described liquid crystal display devices having LED backlights have an advantage, such that local control of the brightness, referred to as local dimming or, more simply, dimming, is easy, for example.

The above described local dimming control is a method for dividing the region of the above described LED backlight which overlaps with the above described display region into a number of blocks, so that the brightness in the above described number of blocks can be controlled independently for each block (see for example Patent Document 1). At this time, one or more LED lights are arranged in each of the above described number of blocks in order to provide an LED backlight as that described above. In addition, the brightness of each block is determined on the basis of the average value of the tone of pixels included in the region which overlaps with the block in the display region. Thus, the brightness can be controlled for each block by applying a strong current to LED lights in blocks where the determined brightness is high and applying a weak current to LED lights in blocks where the determined brightness is low.

Thus, the display in regions which overlap with blocks where the brightness of LED lights is low is dark in the display region, while the display in regions which overlap with blocks where the brightness of LED lights is high is bright in the display region. Therefore, in the case where a video or image displayed during a certain frame period includes a portion which locally includes many pixels having a low tone or displaying black, for example, the contrast between this portion and other, bright portions, is higher.

[Patent Document 1] Japanese Unexamined Patent Publication 2007-183608 (Corresponding US Patent application; US2007/152926A1)

### SUMMARY OF THE INVENTION

### Problem to be Solved by the Invention

The deterioration in the light flux of LED lights depends on the current, so that the light flux deteriorates more rapidly in LED lights to which a strong current keeps being applied than in LED lights to which a weak current keeps being applied.

In the case of local dimming control in the above described LED backlight, the current applied to LED lights is controlled for each block. In addition, the current applied to each LED light is changed during a predetermined period. Therefore, a problem arises with LED backlights where local dimming control is carried out, such that there is a difference in brightness between blocks when the same current is applied to all of the LED lights after long use, for example. This problem easily arises particularly in the case where the same video or images are repeatedly displayed.

An object of the present invention is to provide a technology which makes it possible to delay deterioration in the uniformity of the surface brightness of the above described backlight when all of the lights emit light under the same conditions by using display devices having backlights under local dimming control, for example.

The above described and other objects and new features of the present invention will become clearer from the description in the present specification, as well as the accompanying drawings.

### Means for Solving Problem

The gist of typical embodiments of the invention disclosed in the present specification is described in the following.

(1) A display device having: a backlight having a number of LED (light emitting diode) lights; a display panel having a display region which is a set of pixels of which the tone is adjusted by changing the transmittance of light from the above described LED lights; a first control means for controlling the tone of each pixel; and a second control means for controlling the brightness of each LED light, wherein the above described number of LED lights are arranged in a region that overlaps with the above described display region of the above described display panel, the display device has an illuminance measuring means for measuring the illuminance in the periphery of the above described display device, and the above described second control means makes the brightness of all of the above described LED lights the same in the case where the illuminance as measured by the above described illuminance measuring means is higher than a preset value, and determines the brightness of each LED light on the basis of the tone of the above described pixels controlled by the above described first control means in the case where the illuminance as measured by the above described illuminance measuring means is lower than a preset value.

(2) The display device according to the above (1), wherein the region of the above described display panel which overlaps with the above described display region is divided into a number of blocks, and one or more LED lights in the above described backlight are provided in each of the above described number of blocks, and the above described second control means determines the brightness of each LED light on the basis of the average value of the tone of the pixels included in the region of the above described display region that overlaps with each block in the case where the illuminance as measured by the above described illuminance measuring means is lower than a preset value.

(3) The display device according to the above (2), wherein the brightness of the above described LED lights is controlled by the current applied to the above described LED lights.

(4) The display device according to the above (3), wherein the above described display device has correspondence data for defining the relationship between the average value for the tone of the above described pixels and the current applied to the above described LED light, and the above described second control means calculates the average value for the tone of the pixels included in the region of the above described display region that overlaps with each block in the case where the illuminance as measured by the above described illuminance measuring means is lower than a preset value, and determines the current to be applied to each LED light on the basis of the above described calculated average value and the above described correspondence data.

(5) The display device according to the above (3), wherein the above described display device has two or more pieces of correspondence data which specifies the relationship between the average value of the tone of the above described pixels and the current applied to the above described LED lights, the above described two or more pieces of correspondence data have different relationships between the average value of the tone of the above described pixels and the current applied to the above described LED lights, and the above described second control means selects one piece of correspondence data from among the above described two or more pieces of correspondence data in accordance with the value of the above described measured illuminance, calculates the average value for the tone of the pixels included in the region of the above described display region that overlaps with each block, and determines the current to be applied to each LED light from the above described calculated average value and the above described selected correspondence data in the case where the illuminance as measured by the above described illuminance measuring means is lower than a preset value.

(6) The display device according to the above (1), wherein the above described display panel is a liquid crystal display panel where a liquid crystal material is sealed between a pair of substrates.

### EFFECTS OF THE INVENTION

In the display device according to the present invention, the above described local dimming is controlled in the above described backlight only in the case where the illuminance in the periphery of the display device is lower than a preset value. Therefore, the display device according to the present invention slows the deterioration in the uniformity of the surface brightness of the above described backlight when the same current is applied to all of the LED lights, as compared to in the case where local dimming is controlled all of the time, as according to the prior art.

### BRIEF DESCRIPTION OF THE DRAWINGS

FIG. 1(a) is a schematic perspective diagram showing the principle of local dimming control;

FIG. 1(b) is a graph showing an example of the relationship between the average value of the tone and the current value applied to LED lights;

FIG. 2 is a graph showing the dependency of the light flux from LED lights on the current;

FIG. 3(a) is a schematic block diagram showing an example of the configuration of the liquid crystal display device according to the present embodiment;

FIG. 3(b) is a schematic block diagram showing an example of the configuration of the LED controlling means in FIG. 3(a);

FIG. 4 is a flow chart illustrating an example of the process in the operation of the LED backlight in the liquid crystal display device according to the present embodiment;

FIG. 5 is a flow chart illustrating a modification of the process in the operation of the LED backlight in the liquid crystal display device according to the present embodiment; and

FIG. 6 is a flow chart illustrating a modification of the method for controlling the LED backlight in the liquid crystal display device according to the present embodiment.

### EXPLANATION OF SYMBOLS

1 . . . liquid crystal display panel
2 . . . LED backlight
201 . . . LED light
3 . . . data driver
4 . . . scan driver
5 . . . LED controlling means
501 . . . LD control determining means
502 . . . current value determining means
503 . . . tone-current correspondence data
504 . . . current applying means
6 . . . timing controller
7 . . . illuminance sensor
GL . . . scan signal line
DL . . . video signal line
S_{br} . . . detection signal
SV . . . LD control signal
DATA . . . video signal
I₁ . . . power
I₂ . . . current applied to LED lights

### DETAILED DESCRIPTION OF THE INVENTION

### Best Mode for Carrying Out the Invention

In the following, the embodiments of the present invention are described in detail in reference to the drawings.

Here, the same symbols are attached to components having the same function in all of the drawings illustrating the embodiments, and the descriptions thereof are not repeated.

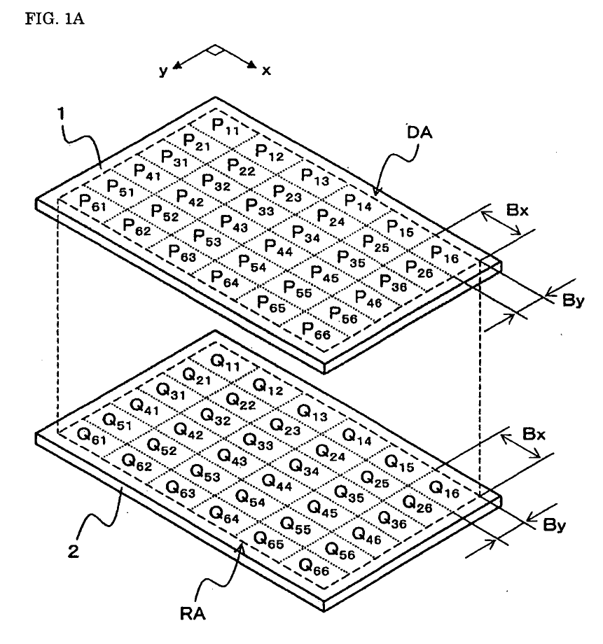

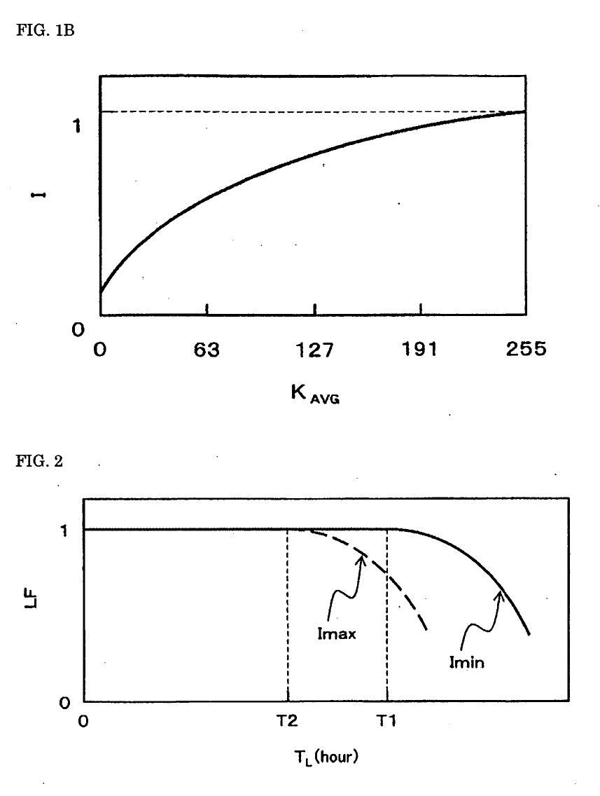

FIGS. 1(a) and 1(b) are schematic diagrams illustrating the principle of the operation of the display device according to the present invention.

FIG. 1(a) is a schematic perspective diagram illustrating the principle of local dimming control. FIG. 1(b) is a graph illustrating an example of the relationship between the average value of the tone and the value of the current applied to LED lights.

Here, in the graph of FIG. 1(b), the lateral axis indicates the average value K_{AVG} of the tone of pixels included in one region in the display region of the display panel, and shows a case where the gradation in the display of each pixel has 256 steps. In addition, the longitudinal axis in FIG. 1(b) indicates a relative value for the current I applied to LED lights, and when the average value K_{AVG} for the gradation is the maximum (255 steps), the current applied to LED lights is 1.

The present invention can be applied to liquid crystal display devices having a backlight where local dimming control is possible, for example. An example of the above described backlight where local dimming control is possible is a direct LED backlight.

As shown in FIG. 1(a), the liquid crystal display device according to the present invention has a liquid crystal display panel 1 and a direct LED backlight 2, for example. The LED backlight 2 has a number of LED lights (not shown) arranged in a matrix in a region RA which overlaps with the display region DA of the liquid crystal display panel 1. At this time, the region RA of the LED backlight 2 is divided into 36 blocks Qᵢⱼ (1≦i≦6, 1≦j≦6) having a size Bx in the direction x, and a size By in the direction y, for example, and one or more LED lights are arranged in each block Qᵢⱼ. Though in FIG. 1, the region RA of the LED backlight 2 is divided into 36 blocks Qᵢⱼ, it may, of course, be divided into another number of blocks.

In addition, each LED light is one light-emitting portion having an LED chip which emits red light, an LED chip which emits green light, and an LED chip which emits blue light, so that the light emits white light when a current flows across the anodes and the cathodes of the respective LED chips. In addition, the LED light may consist of three integrated light emitting parts: one having an LED chip which emits red light, one having an LED chip which emits green light, and one having an LED which emits blue light, which are electrically connected. Furthermore, the LED light may be one light emitting part which emits white light, where an LED chip which emits blue light or near ultraviolet rays and a fluorescent body are combined, for example.

The brightness of the LED light can be controlled by changing the applied current. Therefore, in the case where the region RA of the LED backlights 2 is divided into blocks Qᵢⱼ, the brightness of each block Qᵢⱼ can be changed by changing the current applied to the LED lights included in the block Qᵢⱼ. At this time, the region Pᵢⱼ in the display region DA of the liquid crystal display panel 1 is illuminated with light emitted from the block Qᵢⱼ. Therefore, when the brightness of the block Q where the region P having many pixels of a low tone from among the regions Pᵢⱼ in the display region DA is illuminated with light is lowered and the brightness of the block Q where the region P having many pixels of a high tone is illuminated with light is raised, local contrast in the video or image displayed in the display region DA can be increased. This is the principle of local dimming control.

In the case where local dimming is controlled in the LED backlight 2, the brightness of the respective blocks Qᵢⱼ, that is to say, the current applied to the LED lights included in the respective blocks Qᵢⱼ, is determined on the basis of the correspondence data shown in FIG. 1(b), for example. When the current applied to the LED lights included in the block Q₁₁ is determined under local dimming control, first the average value K_{AVG} of the tone of pixels included in the region P₁₁ which overlaps with the block Q₁₁ is calculated from the gradation data of the video or image displayed on the entirety of the display region DA, for example. Then, the current I (I₁₁) applied to the LED lights included in the block Q₁₁ is determined from the calculated average value K_{AVG} of the gradation and the correspondence data shown in FIG. 1(b).

Here, there are various methods for calculating the average value K_{AVG} of the gradation, and it may be calculated in accordance with the method described in Patent Document 1, for example.

In addition, the current I applied to the LED lights is determined for each block Qᵢⱼ (i, j≠1) through the same process for the remaining blocks Qᵢⱼ (i, j≠1).

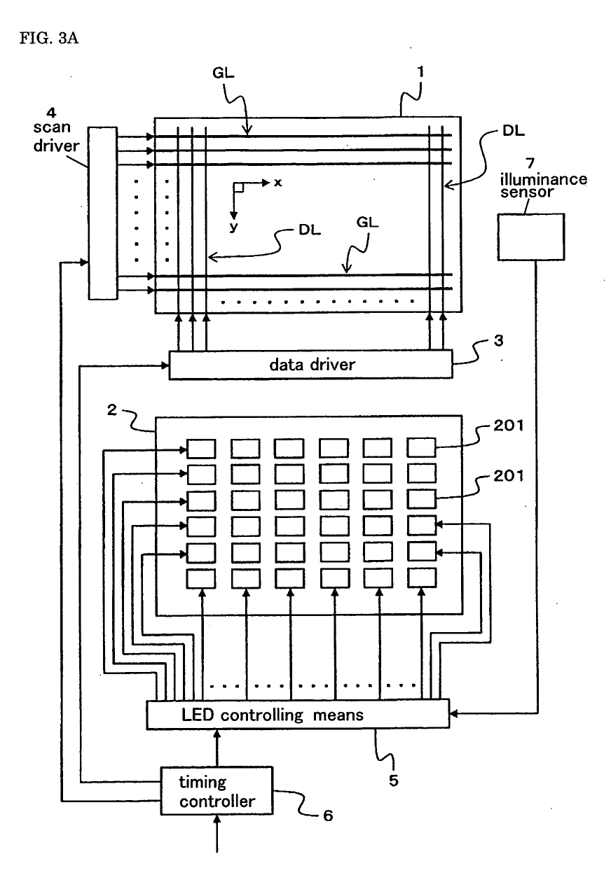

FIG. 2 is a graph illustrating the dependency of the light flux of the LED light on the current.

Here, the lateral axis in FIG. 2 indicates the time during which LED lights emit light TL (in hour units), and T2<T1. In addition, the longitudinal axis in FIG. 2 indicates the relative value for the light flux from the LED lights, and the light flux at the start of operation is 1.

LED lights deteriorate in the light flux after certain period of time after the start of operation, so that the brightness lowers for the same current. At this time, the deterioration in the LED lights in the light flux is in accordance with the applied current and, as shown in FIG. 2, the greater the applied current is, the shorter the time before the light flux starts deteriorating is, for example. Here, in the graph shown in FIG. 2, the distribution shown by the solid line indicates change in the relative value of the light flux over time for a constant, weak current Imin applied to the LED lights, and the light flux starts deteriorating around when the operation time reaches time T1. In addition, in the graph shown in FIG. 2, the distribution shown by the broken line indicates change in the relative value of the light flux over time for a constant, strong current Imax (>Imin) applied to the LED lights, and the light flux starts deteriorating around when the operation time reaches time T2 (<T1).

In the case of conventional LED backlights where there is no control for local dimming, the current applied to the respective LED lights is usually constant, and therefore, the degree of deterioration in the light flux is almost the same for all of the LED lights. Therefore, the longer the operation time of the LED backlight is, the lower the surface brightness throughout the entirety of the display region is, but uniformity can be maintained in the surface brightness.

In the case of an LED backlight where there is control for local dimming, however, the current applied to LED lights is different for each block Qᵢⱼ, and therefore, there is a problem, such that the longer the operation time is, the greater the difference in brightness is for each block for the same current applied to all of the LED lights. This problem easily arises particularly in the case where the same video or image is repeatedly displayed.

### EMBODIMENTS

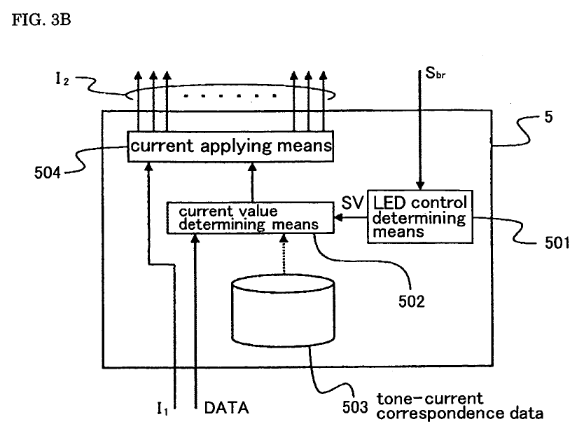

FIGS. 3(a) and 3(b) are schematic diagrams showing the configuration of the liquid crystal display device according to one embodiment of the present invention.

FIG. 3(a) is a schematic block diagram showing an example of the configuration of the liquid crystal display device according to the present embodiment. FIG. 3(b) is a schematic block diagram showing an example of the configuration of the LED controlling means in FIG. 3(a).

As shown in FIG. 3(a), the liquid crystal display device according to the present embodiment has a liquid crystal display panel 1, an LED backlight 2, a data driver 3, a scan driver 4, an LED controlling means 5, a timing controller 6 and an illuminance sensor 7, for example.

The liquid crystal display panel 1 is a transmission type or semi-transmission type liquid crystal display panel, and has a number of scan signal lines GL and a number of video signal lines DL, for example. At this time, the display region DA in the liquid crystal display panel 1 corresponds to the region surrounded by the two scan signal lines GL aligned at the far ends and the two video signal lines DL aligned at the far ends, for example. In addition, the region occupied by one pixel in the display region DA corresponds to a region surrounded by two adjacent scan signal lines GL and two adjacent video signal lines DL, and a TFT element, a pixel electrode and a counter electrode are arranged in the region occupied by each pixel, for example.

Here, the liquid crystal display panel 1 in the liquid crystal display device according to the present embodiment may be a transmission type or semi-transmission type liquid crystal display panel where the configuration of each pixel is the same as the configuration of the pixels in conventional transmission type or semi-transmission type liquid crystal display panels, for example. That is to say, any configuration is possible for each pixel, as long as the tone can be adjusted by changing the transmittance of light by controlling the orientation of liquid crystal molecules, by changing the difference in potential between the pixel electrode and the counter electrode. Therefore, detailed description is omitted for the configuration of pixels in the liquid crystal display panel 1 according to the present embodiment.

The LED backlight 2 is a backlight where local dimming control is possible, and a number of LED lights 201 are arranged in a matrix in a region that overlaps with the display region DA. At this time, the LED light 201 are formed so that the brightness can be controlled independently. Here, one LED light 201 may be made up of one LED or an LED group where a number of LED's are connected in series or in parallel.

The data driver 3 is a drive circuit for generating a video signal (gradation signal) applied to video signal lines DL in the liquid crystal display panel 1, for example.

The scan driver 4 is a drive circuit for generating a scan signal to be applied to scan signal lines GL in the liquid crystal display panel 1, for example.

The LED controlling means 5 is a control circuit for controlling the brightness of the respective LED lights 201, that is to say, the current applied to the respective LED lights 201.

The timing controller 6 is a control circuit for controlling the timing during operation of the data driver 3, the scan driver 4 and the LED controlling means 5, for example.

The illuminance sensor 7 is a sort of photo diode, and placed in such a location that the illuminance in the periphery of the display device can be detected.

In addition, as shown in FIG. 3(b), the LED controlling means 5 has an LD control determining means 501, a current value determining means 502, tone-current correspondence data 503 and a current applying means 504, for example.

The LD control determining means 501 is a means for determining whether or not local dimming is to be controlled on the LED backlight 2 on the basis of the detection signal S_{br} from the illuminance sensor 7. At this time, the LD control determining means 501 turns on the local dimming control by setting the LD control signal SV to 1 in the case where the detection signal S_{br} is a preset value Sₚ or less (S_{br}≦Sₚ), as in Table 1 below, and turns off local dimming control by setting the LD control signal SV to 0 in the case where the detection signal S_{br} is greater than the preset value Sₚ (Sₚ<S_{br}), for example.

TABLE 1

| illuminance | LD control signal |
|---|---|
| S_{br} ≦ Sₚ | SV = 1 (ON) |
| Sₚ < S_{br} | SV = 0 (OFF) |

The current value determining means 502 determines whether or not local dimming is controlled on the basis of the LD control signal SV, and determines the current to be applied to the respective LED lights 201 on the basis of the video signal DATA inputted from the timing controller 5 and the tone-current correspondence data 503 in the case where it is determined that local dimming is controlled (in the case of SV=1). The video signal DATA has the same configuration as the video signal (gradation signal) outputted to the data driver 3 from the timing controller 6, and is a signal having information for controlling the gradation of respective pixels in the display panel 1, for example. In addition, the current applied to all of the LED lights 201 is determined to have the same value without using the video signal DATA inputted from the timing control 5 in the case where it is determined that local dimming is not controlled (in the case of SV=0).

The current applying means 504 generates a current I₂ (power) to be applied to the respective LED lights 201 on the basis of the current applied to the respective LED lights 201 determined by the current value determining means 502 using the power I₁ from the timing controller 5, for example, and supplies the current to the respective LED lights 201.

In the liquid crystal display device according to the present embodiment, the operation for displaying a video or image on the liquid crystal display panel 1, that is to say, the operation for controlling the gradation (transmittance of light) of each pixel in the display region DA on the basis of the video signal inputted from the outside, the clock signal and the power, may be the same as the operation carried out in conventional liquid crystal display devices. Therefore, the detailed description of the operation for displaying a video or image on the liquid crystal display panel 1 is omitted.

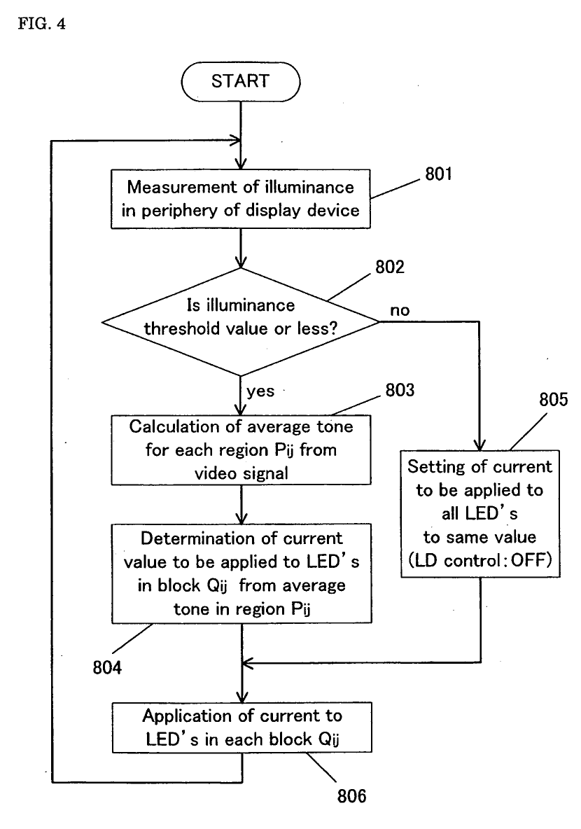

FIG. 4 is a flow chart showing an example of the process in the operation of the LED backlight in the liquid crystal display device according to the present embodiment.

When the LED backlight 2 is operated in the liquid crystal display device according to the present embodiment, as shown in FIG. 4, first the illuminance in the periphery of the display device is measured, for example (step 801). The step 801 is carried out using the illuminance sensor 7, and the results of measurement by the illuminance sensor 7 (for example the detection signal S_{br}) are inputted into the LD control determining means 501.

Next, in the LD control determining means 501, it is determined whether the measured illumination is a preset threshold value or less (step 802). The step 802 is carried out on the determination table shown in the above Table 1, for example, and in the case where the measured illuminance is the threshold value or less (in the case of S_{br}≦Sₚ), the LD control signal SV is set to 1 and outputted to the current value determining means 502. In addition, in the case where the measured illuminance is greater than the threshold value (Sₚ<S_{br}), the LD control signal SV is set to 0 and outputted to the current value determining means 502. Here, the threshold value for the illuminance used for determination in the step 802 can be changed to an appropriate value, and it is preferable to set it to approximately 200 lx (lux) to 1000 lx, for example.

In the case where the measured illuminance is the threshold value or less (in the case of YES) in the determination in the step 802, local dimming control is turned ON. Thus; the average gradation (average value of gradation) for each region Pᵢⱼ is calculated from the video signal DATA (step 803), so that the value of the current applied to the LED lights 201 in the block Qᵢⱼ can be determined from the average gradation in the region Pᵢⱼ (step 804). The steps 803 and 804 are carried out in the current value determining means 502. At this time, in the step 803, the video signal DATA for one frame is divided into separate signals for the respective regions Pᵢⱼ, for example, and the average value is calculated from the gradation information (or brightness information) included in the above described separate signals. In addition, in the step 804, the value of the current applied to the LED lights 201 in the respective blocks Qᵢⱼ is determined on the basis of the average gradation for the regions Pᵢⱼ as calculated in the step 803 and the tone-current correspondence data 503 shown in FIG. 1(b), for example. In addition, the information on the value of the current applied to the respective LED lights 201 as determined in the step 804 is outputted to the current applying means 504.

Meanwhile, in the case where the measured illuminance is greater than the threshold value in the determination in the step 802 (in the case of NO), local dimming control is turned OFF. Thus, the current applied to the LED lights 201 is set to the same value for all of the blocks Qᵢⱼ (step 805). The step 805 is carried out in the current value determining means 502. In addition, the information on the value of the current applied to the respective LED lights 201 as determined in the step 805 is outputted to the current applying means 504.

Next, the current to be applied to the respective LED lights 201 is actually generated on the basis of the value of the current applied to the respective LED lights 201 as determined during the process in the steps 803 and 804, as well as the value of the current applied to the respective LED lights 201 as determined during the process in step 805, and the current is applied to the respective LED lights 201 (step 806). The step 806 is carried out in the current applying means 504. In addition, when the generated current is applied to the respective LED lights 201, an image in accordance with the video signal used in the step 803 is in sync with the timing for display on the liquid crystal display panel 1, for example.

When the sequence of processes in the steps 801 to 806 is carried out, so that the operation control for the LED backlight 2 which is in sync with the display of the video data for one frame is finished, for example, the process returns to the step 801, so that the operation control for the LED backlight 2 which is in sync with display of video data for the next frame is carried out.

When this operation control for the LED backlight 2 is carried out, local dimming control can be automatically switched between ON and OFF in accordance with the brightness of the room where the liquid crystal display device is installed, for example.

Incidentally, local dimming control is a control method for increasing local contrast by creating regions where the backlight is bright and regions where the backlight is dark within the display region DA in accordance with the distribution in the gradation (brightness) of the displayed video or image.

However, local dimming control is effective in the case where the illuminance is low in the space where the liquid crystal display device is installed; while the contrast barely changes under local dimming control, due to the effects of reflection of external light from the display surface of the liquid crystal display panel 1, for example, in the case where the illuminance of the space where the liquid crystal display device is installed is high. That is to say, the contrast when local dimming control is turned ON and the contrast when it is turned OFF are basically the same in the case where the illuminance of the space where the liquid crystal display device is installed is high. Therefore, the effects of increasing the contrast under local dimming control are not lost in the liquid crystal display device according to the present embodiment, as long as the threshold value (value Sₚ) for the illuminance is set to an appropriate value.

In addition, the same current is applied to all of the LED lights 201 during the period when local dimming control is turned OFF in the case where the illuminance is high in the space where the liquid crystal display device is installed. Therefore, the inconsistency in the deterioration of the respective LED lights 201 in the light flux becomes small in comparison with the case where local dimming is controlled all of the time, irrespectively of the illuminance in the space where the liquid crystal display device is installed. Accordingly, in the liquid crystal display device according to the present embodiment, deterioration in the uniformity of the surface brightness of the backlight when the same current is applied to all of the LED lights can be slowed, for example.

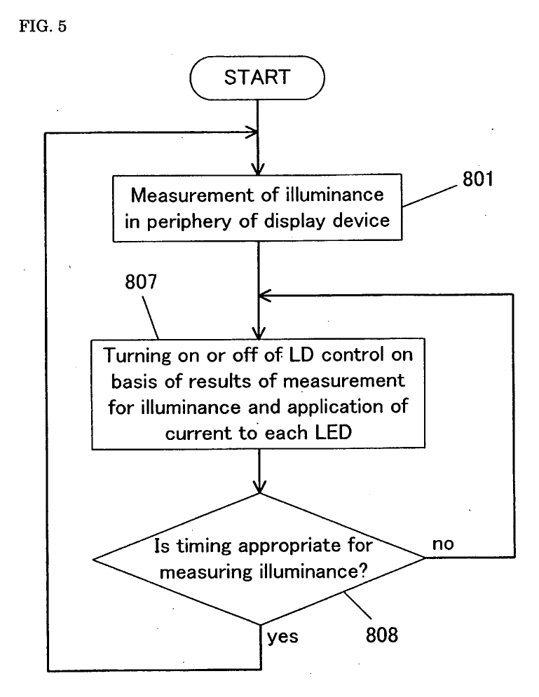

FIG. 5 is a flow chart illustrating a modification of the process for operation of the LED backlight in the liquid crystal display device according to the present embodiment.

During the process for operation of the LED backlight 2 shown in FIG. 4, the illuminance is measured for each frame of a video, for example, and it is determined whether or not local dimming is controlled. When a video or image is displayed on the liquid crystal display device, however, in many cases the illuminance is constant over a long period of time, for example. In such cases, it is not efficient to operate the LED backlight 2 through the process shown in FIG. 4. Accordingly, in the liquid crystal display device according to the present embodiment, the LED backlight 2 may be operated through the process shown in FIG. 5, for example.

In the process for operation of the Led backlight 2 shown in FIG. 5, first the illuminance in the periphery of the display device is measured (step 801). Next, local dimming control (LD control) is turned ON or OFF on the basis of the illuminance as measured in the step 801, so that a current is applied to the respective LED lights 201 (step 807). In the step 807, the process in the steps 803 and 804 or the process in the step 805 is carried out.

Next, whether or not the timing is appropriate for measuring the illuminance is determined (step 808). In the step 808, the timing is determined when a certain period of time has elapsed after the previous measurement (step 801). In addition, in the step 808, whether or not the difference between the illuminance at the previous measurement (step 801) and the illuminance at that time is greater than a preset value may be determined, for example.

In the case where it is determined that the timing is not appropriate for measuring the illuminance in the step 808 (in the case of NO), the procedure returns to the step 807, and the process in the steps 803 and 804 or the process in the step 805 is carried out under the same conditions as before determination.

In the case where it is determined that the timing is appropriate for measuring the illuminance in the step 808 (in the case of YES), the procedure returns to the step 801, and the illuminance is measured and the process in the steps 803 and 804 or the process in the step 805 carried out on the basis of the results of measurement.

Thus, the number of times the illuminance is measured can be reduced, and the power required for the operation of the LED controlling means 5, for example, can be reduced.

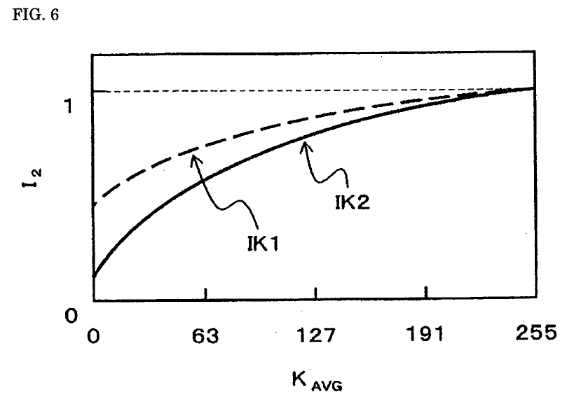

FIG. 6 is a graph illustrating a modification of the method for controlling the LED backlights in the liquid crystal display device according to the present embodiment.

Here, the lateral axis in the graph of FIG. 6 indicates the average value K_{AVG} of the gradation of pixels included in one region in the display region of the display panel in the case where there are 256 steps in the display gradation for each pixel. In addition, the longitudinal axis in FIG. 6 indicates the relative value of the current I2 applied to the LED lights, where the current applied to the LED lights when the average value K_{AVG} of the gradation is maximum (255 steps) is set to 1.

In the present embodiment, a case where local dimming control is turned ON when the illuminance in the periphery of the display device (detection signal S_{br}) is lower than a certain threshold value Sₚ while local dimming control is turned OFF when it is higher than the threshold value Sₚ is cited as an example of the method for controlling the LED backlights 2.

As in the liquid crystal display device according to the present embodiment, however, two or more threshold values may be set, so that the effects of local dimming control can be change step by step in the case where local dimming control is automatically switched between ON and OFF in accordance with the illuminance in the periphery. That is to say, two threshold values: Sₚ₁ and Sₚ₂ (>Sₚ₁), may be set, as shown in Table 2 below, so that local dimming can be controlled using the correspondence data IK2 when the measured illuminance (detection signal S_{br}) is the threshold value Sₚ₁ or less, and local dimming is controlled using the correspondence data IK1 when the measured illuminance (detection signal S_{br}) is greater than the threshold value Sₚ₁ or the threshold value Sₚ₂ or less in the case where local dimming control is automatically switched between ON and OFF in accordance with the illuminance in the periphery. In addition, local dimming control is turned OFF when the measured illuminance (detection signal S_{br}) is greater than the threshold value Sₚ₂.

TABLE 2

| illuminance | LED control signal | correspondence data |
|---|---|---|
| S_{br} ≦ Sₚ₁ | SV = 2 (ON) | IK2 |
| Sₚ₁ < S_{br} ≦ Sₚ₂ | SV = 1 (ON) | IK1 |
| Sₚ₂ < S_{br} | SV = 0 (OFF) | — |

At this time, the two pieces of correspondence data IK1 and IK2 show that the relationship between the average value K_{AVG} of the gradation and the relative value of the current I₂ applied to the LED lights 201 is as shown in FIG. 6, for example.

Though concrete embodiments of the present invention are described, the present invention is not limited to the above described embodiments, and various modifications are, of course, possible, within such a scope as not to deviate from the gist of the invention.

1. A display device, comprising: a backlight having a number of LED (light emitting diode) lights; a display panel having a display region which is a set of pixels of which the tone is adjusted by changing the transmittance of light from said LED lights; a first control means for controlling the tone of each pixel; and a second control means for controlling the brightness of each LED light, wherein said number of LED lights are arranged in a region that overlaps with said display region of said display panel, characterized in that
the display device has an illuminance measuring means for measuring the illuminance in the periphery of said display device, and
said second control means makes the brightness of all of said LED lights the same in the case where the illuminance as measured by said illuminance measuring means is higher than a preset value, and determines the brightness of each LED light on the basis of the tone of said pixels controlled by said first control means in the case where the illuminance as measured by said illuminance measuring means is lower than a preset value.

2. The display device according to claim 1, characterized in that
the region of said display panel which overlaps with said display region is divided into a number of blocks, and one or more LED lights in said backlight are provided in each of said number of blocks, and
said second control means determines the brightness of each LED light on the basis of the average value of the tone of the pixels included in the region of said display region that overlaps with each block in the case where the illuminance as measured by said illuminance measuring means is lower than a preset value.

3. The display device according to claim 2, characterized in that the brightness of said LED lights is controlled by the current applied to said LED lights.

4. The display device according to claim 3, characterized in that
said display device has correspondence data for defining the relationship between the average value for the tone of said pixels and the current applied to said LED light, and
said second control means calculates the average value for the tone of the pixels included in the region of said display region that overlaps with each block in the case where the illuminance as measured by said illuminance measuring means is lower than a preset value, and determines the current to be applied to each LED light on the basis of said calculated average value and said correspondence data.

5. The display device according to claim 3, characterized in that
said display device has two or more pieces of correspondence data which specifies the relationship between the average value of the tone of said pixels and the current applied to said LED lights,
said two or more pieces of correspondence data have different relationships between the average value of the tone of said pixels and the current applied to said LED lights, and
said second control means selects one piece of correspondence data from among said two or more pieces of correspondence data in accordance with the value of said measured illuminance, calculates the average value for the tone of the pixels included in the region of said display region that overlaps with each block, and determines the current to be applied to each LED light from said calculated average value and said selected correspondence data in the case where the illuminance as measured by said illuminance measuring means is lower than a preset value.

6. The display device according to claim 1, characterized in that said display panel is a liquid crystal display panel where a liquid crystal material is sealed between a pair of substrates.
